(19) United States
(12) Patent Application Publication
(10) Pub. No.: US 2024/0214135 A1
(43) Pub. Date: Jun. 27, 2024

(54) TERMINAL

(71) Applicant: NTT DOCOMO, INC., Tokyo (JP)

(72) Inventors: Shohei Yoshioka, Tokyo (JP); Hiroki Harada, Tokyo (JP); Shinya Kumagai, Tokyo (JP); Satoshi Nagata, Tokyo (JP)

(73) Assignee: NTT DOCOMO, INC., Tokyo (JP)

(21) Appl. No.: 17/914,109

(22) PCT Filed: Mar. 24, 2020
(86) PCT No.: PCT/JP2020/013153

§ 371 Date: Sep. 23, 2022

(51) Int. Cl. H04L 5/00; H04W 72/232; H04W 72/51; H04W 76/20

(52) U.S. Cl. CPC H04L 5/001; H04W 72/232; H04W 72/51; H04W 76/20

(57) ABSTRACT

The terminal includes a communication unit that executes data communication via a plurality of component carriers, and the receiving unit executes predetermined communication that is communication of a transport block across the plurality of component carriers.

### TECHNICAL FIELD

The present disclosure relates to a terminal that executes radio communication, and particularly to a terminal that executes radio communication using a large number of component carriers.

### BACKGROUND ART

The 3rd Generation Partnership Project (3GPP) specifies the 5th generation mobile communication system (5G, also called New Radio (NR) or Next Generation (NG)), and is also preparing the next-generation specifications called Beyond 5G, 5G Evolution, or 6G.

3GPP Release 15 and Release 16 (NR) specify the operation of multiple frequency ranges, specifically, the band including FR1 (410 MHz to 7.125 GHz) and FR2 (24.25 GHz to 52.6 GHz).

Further, NR that supports up to 71 GHz over 52.6 GHz is also under study (Non-Patent Literature 1). In addition, Beyond 5G, 5G Evolution, or 6G (Release-18 or later) aims to support frequency bands above 71 GHz.

### CITATION LIST

### Non-Patent Literature

Non-Patent Literature 1: “New WID on Extending current NR operation to 71 GHz”, RP-193229, 3GPP TSG RAN Meeting #86, 3GPP, December 2019

### SUMMARY OF INVENTION

As described above, it is assumed that when the usable frequency band is expanded, the possibility that more component carriers (CC) will be set increases.

In Carrier Aggregation (CA), the number of CCs that can be set is defined. For example, in 3GPP Release 15 and Release 16, the maximum number of CCs that can be set for a terminal (User Equipment, UE) is 16 in each of downlink (DL) and uplink (UL).

Under such a background, the inventors, as a result of diligent studies, have paid attention to the assumption that the channel qualities regarding a large number of CCs are similar, and have found that it is possible to improve the flexibility of communication control using a plurality of CCs.

Therefore, the following disclosure is made in view of such a situation, and an object thereof is to provide a terminal that can realize improvement in flexibility of communication control when a large number of component carriers (CCs) are set.

One aspect of the present disclosure is a terminal, which includes a communication unit that executes data communication via a plurality of component carriers, and the receiving unit executes predetermined communication that is communication of a transport block across the plurality of component carriers.

### BRIEF DESCRIPTION OF DRAWINGS

FIG. 1 is an overall schematic configuration diagram of a radio communication system 10.

FIG. 2 is a diagram illustrating frequency ranges used in the radio communication system 10.

FIG. 3 is a diagram illustrating a configuration example of a radio frame, a subframe, and a slot used in the radio communication system 10.

FIG. 4 is a functional block configuration diagram of a UE 200.

FIG. 5 is a diagram for explaining a CC group.

FIG. 6 is a diagram for explaining a CC group.

FIG. 7 is a diagram for explaining a TB.

FIG. 8 is a diagram for explaining a PRB.

FIG. 9 is a diagram for explaining an RE.

FIG. 10 is a diagram illustrating an operation example 1.

FIG. 11 is a diagram illustrating an operation example 2.

FIG. 12 is a diagram for explaining Modification 1.

FIG. 13 is a diagram illustrating an example of a hardware configuration of the UE 200.

### DESCRIPTION OF EMBODIMENTS

Embodiments will be described below with reference to the drawings. The same functions and configurations are designated by the same or similar reference numerals, and description thereof will be omitted as appropriate.

### Embodiment

### (1) Overall Schematic Configuration of Radio Communication System

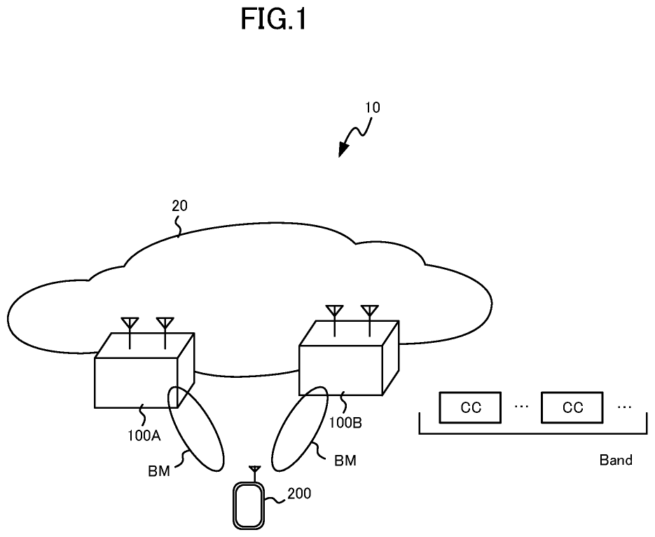

FIG. 1 is an overall schematic configuration diagram of a radio communication system 10 according to the present embodiment. The radio communication system 10 is a radio communication system according to 5G New Radio (NR), and includes a Next Generation-Radio Access Network 20 (hereinafter, NG-RAN 20) and a terminal 200 (hereinafter, UE 200).

The radio communication system 10 may be a radio communication system according to a system called Beyond 5G, 5G Evolution, or 6G.

The NG-RAN 20 includes a radio base station 100A (hereinafter, gNB 100A) and a radio base station 100B (hereinafter, gNB 100B). Note that the specific configuration of the radio communication system 10 including the numbers of gNBs and UEs is not limited to the example illustrated in FIG. 1.

The NG-RAN 20 actually includes a plurality of NG-RAN Nodes, specifically, gNBs (or ng-eNBs), and is connected to a 5G-compliant core network (5GC, not illustrated). Note that the NG-RAN 20 and 5GC may be simply expressed as “network”.

The gNB 100 and gNB 100B are radio base stations according to 5G, and execute radio communication according to 5G with the UE 200. The gNB100, gNB100B, and UE 200 control radio signals transmitted from a plurality of antenna elements, and thereby can support Massive MIMO (Multiple-Input Multiple-Output) that generates a beam BM with higher directivity, Carrier Aggregation (CA) that bundles and uses a plurality of component carriers (CCs), Dual Connectivity (DC) that simultaneously performs communication between a UE and each of two NG-RAN nodes, and the like.

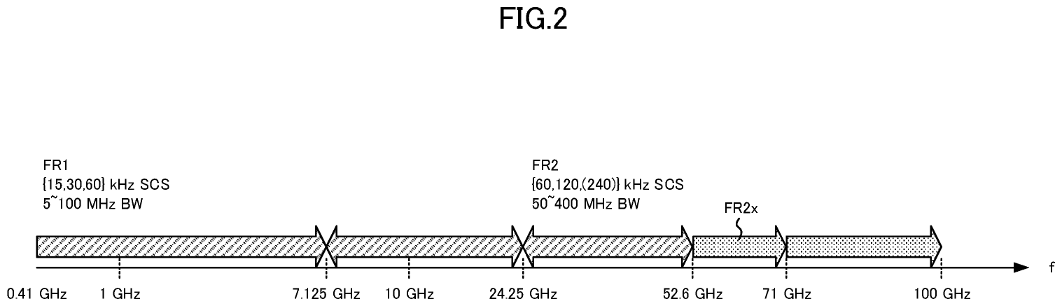

Further, the radio communication system 10 supports a plurality of frequency ranges (FRs). FIG. 2 illustrates frequency ranges used in the radio communication system 10.

As illustrated in FIG. 2, the radio communication system 10 supports FR1 and FR2. The frequency band of each FR is as follows.
FR1: 410 MHz to 7.125 GHz
FR2: 24.25 GHz to 52.6 GHz

FR1 uses 15, 30, or 60 kHz Sub-Carrier Spacing (SCS) and may use a bandwidth (BW) of 5 to 100 MHz. FR2 has a higher frequency than FR1, uses 60, or 120 kHz (240 kHz may be included) SCS, and may use a bandwidth (BW) of 50 to 400 MHz.

Note that SCS may be interpreted as numerology. The numerology is defined in 3GPP TS38.300 and corresponds to one subcarrier spacing in the frequency domain.

Furthermore, the radio communication system 10 also supports a higher frequency band than the frequency band of FR2. Specifically, the radio communication system 10 supports a frequency band of more than 52.6 GHz and up to 114.25 GHz. Such a high frequency band may be referred to as “FR2x” for convenience.

In order to solve such a problem, when a band exceeding 52.6 GHz is used, Cyclic Prefix-Orthogonal Frequency Division Multiplexing (CP-OFDM)/Discrete Fourier Transform-Spread (DFT-S-OFDM) having a larger Sub-Carrier Spacing (SCS) may be applied.

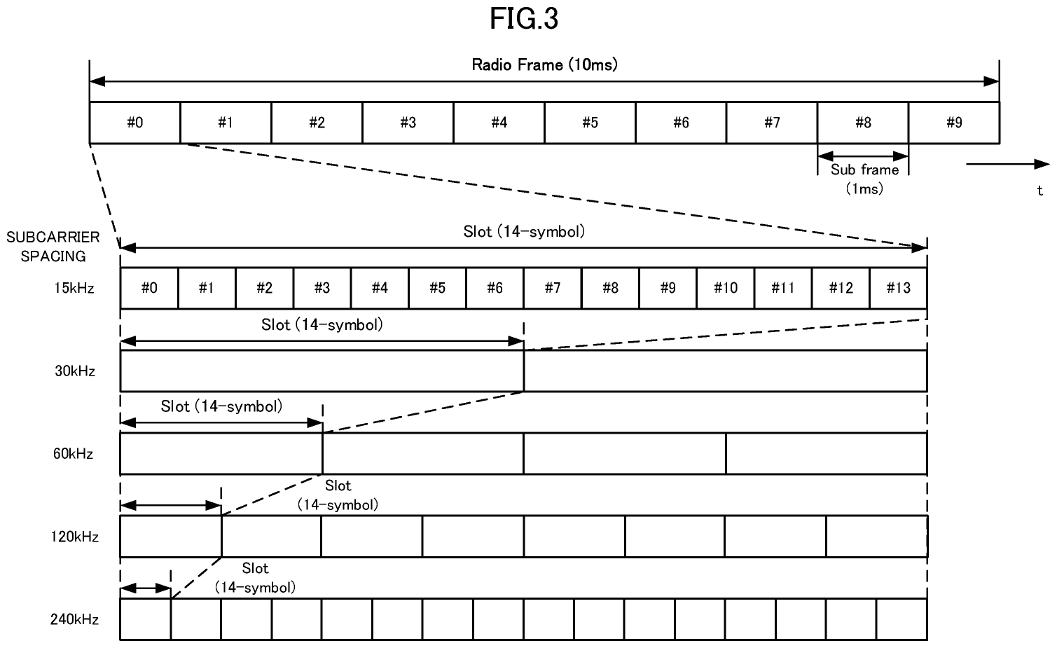

FIG. 3 illustrates a configuration example of a radio frame, a subframe, and a slot used in the radio communication system 10.

As illustrated in FIG. 3, one slot is composed of 14 symbols, and the larger (wider) the SCS, the shorter the symbol period (and the slot period). The SCS is not limited to the intervals (frequency) illustrated in FIG. 3. For example, 480 kHz, 960 kHz or the like may be used.

Further, the number of symbols forming one slot does not necessarily have to be 14 (for example, 28, 56). Further, the number of slots per subframe may vary depending on the SCS.

The time direction (t) illustrated in FIG. 3 may be called a time domain, a symbol period, a symbol time, or the like. Further, the frequency direction may be called a frequency domain, a resource block, a subcarrier, a BWP (Bandwidth part), or the like.

### (2) Functional Block Configuration of Radio Communication System

Next, a functional block configuration of the radio communication system 10 will be described. Specifically, the functional block configuration of UE 200 will be described.

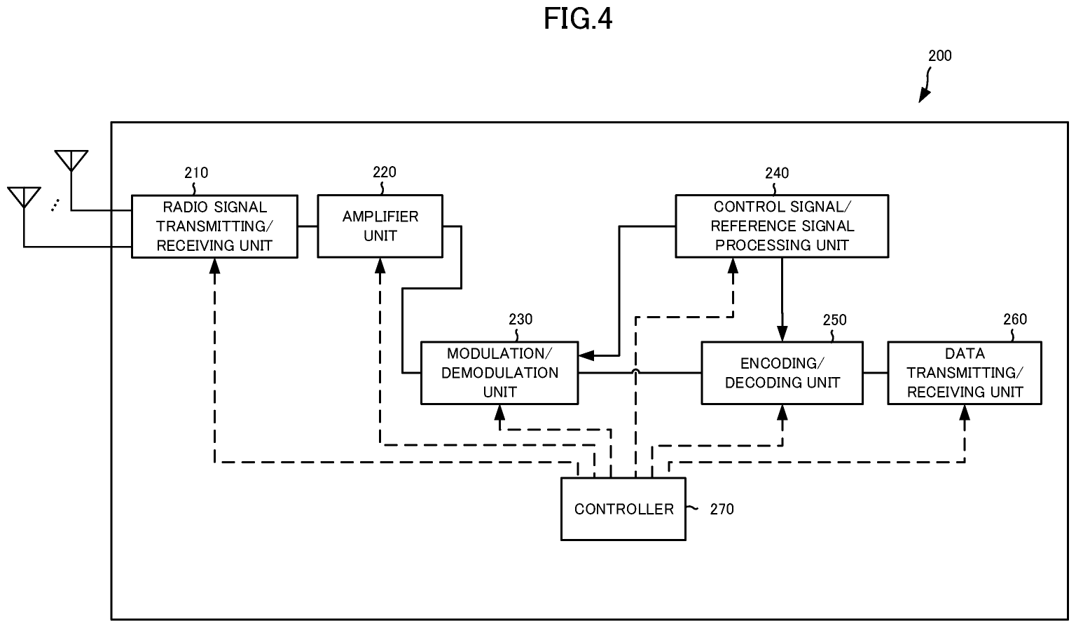

FIG. 4 is a functional block configuration diagram of the UE 200. As illustrated in FIG. 4, the UE 200 includes a radio signal transmitting/receiving unit 210, an amplifier unit 220, a modulation/demodulation unit 230, a control signal/reference signal processing unit 240, an encoding/decoding unit 250, a data transmitting/receiving unit 260, and a controller 270.

The radio signal transmitting/receiving unit 210 transmits/receives a radio signal according to NR. The radio signal transmitting/receiving unit 210 supports Massive MIMO, CA that bundles and uses a plurality of CCs, DC that simultaneously performs communication between a UE and each of two NG-RAN Nodes, and the like.

In the embodiment, the radio signal transmitting/receiving unit 210 constitutes a communication unit that executes data communication via a plurality of CCs. The data may be data received via PDSCH (Physical Downlink Shared Channel). The data may be data transmitted via a PUSCH (Physical Uplink Shared Channel). The radio signal transmitting/receiving unit 210 executes predetermined communication which is communication of one TB (Transport Block) across a plurality of CCs.

The amplifier unit 220 includes a PA (Power Amplifier)/LNA (Low Noise Amplifier) or the like. The amplifier unit 220 amplifies a signal output from the modulation/demodulation unit 230 to a predetermined power level. Further, the amplifier unit 220 amplifies an RF signal output from the radio signal transmitting/receiving unit 210.

The modulation/demodulation unit 230 executes data modulation/demodulation, transmission power setting, resource block allocation, and the like for each predetermined communication destination (gNB 100 or another gNB). The modulation/demodulation unit 230 may apply Cyclic Prefix-Orthogonal Frequency Division Multiplexing (CP-OFDM)/Discrete Fourier Transform-Spread (DFT-S-OFDM). Further, DFT-S-OFDM may be used not only in the uplink (UL) but also in the downlink (DL).

The control signal/reference signal processing unit 240 executes processing regarding various control signals transmitted and received by the UE 200 and processing regarding various reference signals transmitted and received by the UE 200.

Specifically, the control signal/reference signal processing unit 240 receives various control signals transmitted from the gNB 100 via a predetermined control channel, for example, a radio resource control layer (RRC) control signal. In addition, the control signal/reference signal processing unit 240 transmits various control signals to the gNB 100 via a predetermined control channel.

The control signal/reference signal processing unit 240 executes processing using a reference signal (RS) such as a demodulation reference signal (DMRS) and a phase tracking reference signal (PTRS).

The DMRS is a reference signal (pilot signal) known between the terminal-specific base station and terminal for estimating a fading channel used for data demodulation. The PTRS is a terminal-specific reference signal for the purpose of estimating phase noise, which is a problem in high frequency bands.

The reference signal may include Channel State Information-Reference Signal (CSI-RS), Sounding Reference Signal (SRS), and Positioning Reference Signal (PRS) for position information, in addition to the DMRS and PTRS.

Further, the channel includes a control channel and a data channel. The control channel includes PDCCH (Physical Downlink Control Channel), PUCCH (Physical Uplink Control Channel), RACH (Random Access Channel), Downlink Control Information (DCI) including Random Access Radio Network Temporary Identifier (RA-RNTI), Physical Broadcast Channel (PBCH), and the like.

Further, the data channel includes PDSCH (Physical Downlink Shared Channel), PUSCH (Physical Uplink Shared Channel), and the like. Data means data transmitted via the data channel. The data channel may be read as a shared channel.

The encoding/decoding unit 250 executes data division/concatenation, channel coding/decoding, and the like for each predetermined communication destination (gNB 100 or another gNB).

Specifically, the encoding/decoding unit 250 divides data output from the data transmitting/receiving unit 260 into a predetermined size, and executes channel coding on the divided data. Also, the encoding/decoding unit 250 decodes the data output from the modulation/demodulation unit 230 and connects the decoded data.

The data transmitting/receiving unit 260 executes transmission/reception of Protocol Data Unit (PDU) and Service Data Unit (SDU). Specifically, the data transmitting/receiving unit 260 executes assembly/disassembly or the like of PDU/SDU in a plurality of layers (medium access control layer (MAC), radio link control layer (RLC), packet data convergence protocol layer (PDCP), etc.). Further, the data transmitting/receiving unit 260 executes data error correction and retransmission control based on hybrid ARQ (Hybrid automatic repeat request).

The controller 270 controls each functional block configuring the UE 200. In particular, in the present embodiment, the controller 270 controls communication of a plurality of CCs using one or more DCIs that are received via a predetermined CC when a component carrier group (hereinafter, CC group) composed of a plurality of CCs is applied. The predetermined CC may be one or more CCs included in the plurality of CCs. The controller 270 determines whether or not a predetermined condition is satisfied. The predetermined condition may be a condition that a CC group is applied, that is, communication of a plurality of CCs is controlled using DCI received via a predetermined CC.

### (3) CC Group

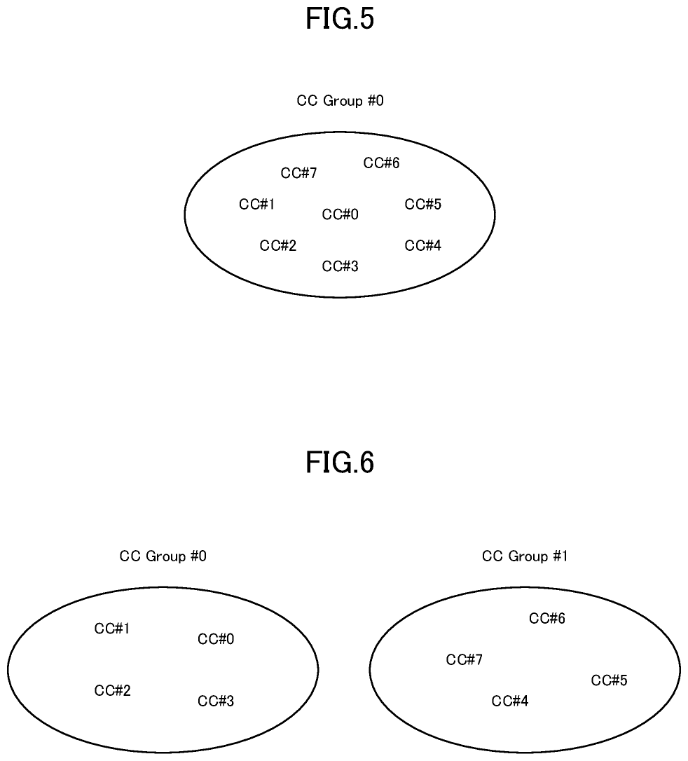

FIGS. 5 and 6 are diagrams for explaining the CC group according to the present embodiment. As described above, the CC group includes a plurality of CCs.

As illustrated in FIG. 5, one CC group may be set. FIG. 5 exemplifies a case where a CC group #0 is set to CC #0 to CC #7. The CC group #0 may be referred to as a serving cell group. The CC group #0 may be set by a higher layer parameter. For example, the CC group #0 may be set by an RRC message. In the case where one CC group is set, a plurality of CCs included in the CC group may be predetermined.

As illustrated in FIG. 6, a plurality of CC groups may be set. FIG. 6 exemplifies a case where a CC group #0 is set to the CC #0 to CC #3 and a CC group #1 is set to the CC #4 to CC #7. The CC group #0 and CC group #1 may be referred to as a serving cell group. The CC group #0 and CC group #1 may be set by a higher layer parameter. For example, the CC group #0 and CC group #1 may be set by an RRC message.

In FIGS. 5 and 6, the CC group may be applied to the UE 200 by the information element included in the RRC message or may be applied to the UE 200 by the information element included in the DCI. The CC group applied to the UE 200 may be a CC group selected from the CC groups set by the higher layer parameter. The applied may be referred to as enable or activate.

Similarly, the CC group may not be applied to the UE 200 by the information element included in the RRC message, and may not be applied to the UE 200 by the information element included in the DCI. The CC group that is not applied to the UE 200 may be a CC group selected from the CC groups set by the higher layer parameter. The non-applied may be referred to as disable or inactivate.

First, the plurality of CCs included in the CC group may be CCs that are consecutive in an intra-band. The plurality of CCs included in the CC group may be CCs included in a scheduling cell or CCs included in a PDCCH search space. The PDCCH search space may be defined by RNTI such as SI (System Information)-RNTI (Radio Network Temporary Identifier), RA (Random Access)-RNTI, TC (Temporary Cell)-RNTI, C (Cell)-RNTI, P (Paging)-RNTI, INT (Interruption)-RNTI, SFI (Slot Format Indication)-RNTI, TPC (Transmit Power Control)-PUSCH-RNTI, TPC-PUCCH-RNTI, TPC-SRS-RNTI, and SP (Semi Persistent)-CSI (Channel State Information))-RNTI. The plurality of CCs included in the CC group may be CCs to which the setting of the serving cell is commonly applied. The setting of the serving cell may include TDD DL/UL Configuration and SCS specific carrier list.

Secondly, the CC group may be set and applied for one purpose or operation. The CC group may be set and applied for two or more purposes or operations. The predetermined purpose or operation may include UL scheduling, DL scheduling, BWP switching, TCI (Transmission Configuration Indicator) switching, and SFI (Slot Format Indicator).

A case where the CC group is set and applied for one purpose or operation will be described with reference to FIG. 6. For example, the CC group #0 may be a group for UL scheduling and the CC group #1 may be a group for DL scheduling. The CC group #0 may be a group for scheduling (UL and DL), and the CC group #1 may be a group for BWP switching. The CC group #0 may be a group for TCI switching, and the CC group #1 may be a group for SFI. With such a configuration, it is possible to flexibly set the CC group, which in turn improves the performance.

A case where the CC group is set and applied for two or more purposes or operations will be described with reference to FIG. 6. For example, the CC group #0 may be a group for scheduling (UL and DL) and SFI, and the CC group #1 may be a group for BWP switching and TCI switching. With such a configuration, the configuration of the gNB 100 can be simplified.

Under such a background, the UE 200 may receive the RRC message including the information element instructing the application of the CC group from the NG-RAN 20. The CC group applied to the UE 200 may be selected from the CC groups set in the UE 200 by the NG-RAN 20. The information element instructing the application of the CC group may include identification information of the CC group to be applied to the UE 200 and the effect of applying the CC group (for example, enable). The UE 200 may receive the RRC message including the information element instructing the non-application of the CC group from the NG-RAN 20. The information element instructing the non-application of the CC group may include identification information of the CC group not to be applied to the UE 200 and the effect of applying the CC group (for example, disable). The information element instructing the application of the CC group is bitmap information capable of specifying the CC by the bit position, and each bit may be an information element indicating whether or not the CC corresponding to the bit position is included in the CC group. The information element instructing the application of the CC group may be a combination of CC identification information and an information element indicating whether or not to be included in the CC group.

The UE 200 may specify the CC group to be applied to the UE 200 based on the information element included in the DCI. For example, the UE 200 specifies the CC group to be applied to the UE 200 based on the CI stored in the CI (Channel Indicator) field included in the DCI. For example, taking the case illustrated in FIG. 6 as an example, when the CI has a value indicating the CC #0, the CC group to be applied to the UE 200 is the CC group #0 including the CC #0. On the other hand, when the CI has a value indicating the CC #5, the CC group to be applied to the UE 200 is the CC group #1 including the CC #0.

### (4)TB

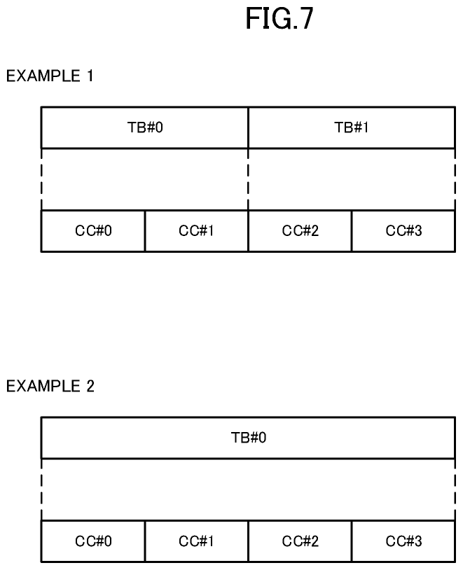

FIG. 7 is a diagram for explaining the TB according to the embodiment. FIG. 7 exemplifies a case where the CC group includes the CC #0 to CC #3. Further, a case where the TB spans a plurality of CCs, that is, a case where the above-described predetermined condition is satisfied will be exemplified. Note that the fact that a TB spans a plurality of CCs may mean that a certain TB is mapped to a plurality of CCs and transmitted or received.

First, one TB #0 may be mapped to one CC group (CC #0 to CC #3). In other words, the TB #0 may span the CC #0 to CC #3 (see Example 1).

Secondly, two TBs (TB #0 and TB #1) may be mapped to one CC group (CC #0 to CC #3). In other words, the TB #0 may span the CC #0 to CC #1, and the TB #1 may span the CC #2 to CC #3 (see Example 2).

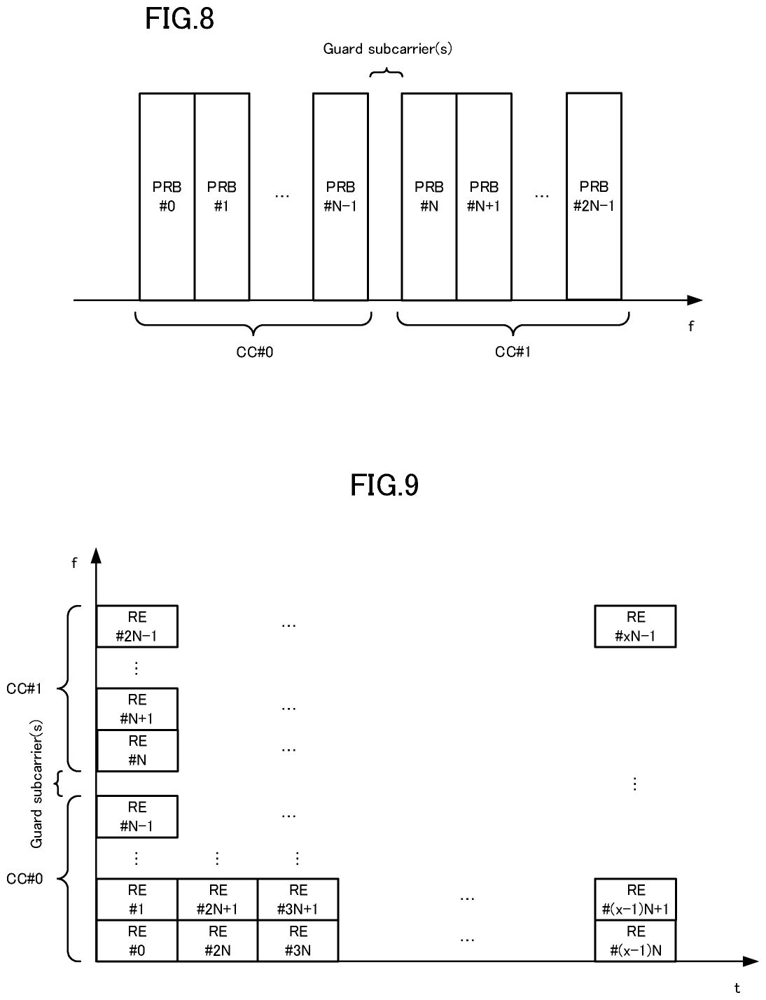

In such a case, taking a case where the TB #0 spans the CC #0 to CC #1 (Example 2 illustrated in FIG. 7) as an example, PRB (Physical Resource Block) and RE (Resource Element) capable of mapping the TB #0 are as illustrated in FIGS. 8 and 9, respectively.

The PRB capable of mapping the TB #0 spans multiple CCs (CC #0 to CC #1) as illustrated in FIG. 8. Therefore, the size of TB (TBS (Transport Block Size) is determined by the number of PRBs allocated to the UE 200 across a plurality of CCs.

Similarly, the RE allocated to the UE 200 in each PRB spans multiple CCs (CC #0 to CC #1) as illustrated in FIG. 9. The number of allocated REs in one PRB is determined based on the information element (scheduling parameter) included in the DCI and the information element (higher layer parameter) included in the RRC message. The scheduling parameter may include an information element included in the DCI, that is, a value stored in an FDRA (Frequency Domain Resource Allocation) field, a value stored in a TDRA (Time Domain Resource Allocation) field, and a value stored in an MCS (Modulation Coding Scheme). The higher layer parameters may include RA Type used for frequency domain resource allocation, MCS table used for MCS determination, and the like.

Here, the number of REs allocated in one PRB may be common to each of the multiple CCs that the TB spans (e.g., N′_RE), and may be different for each of the multiple CCs that the TB spans (e.g., N′_RE_CC0, N′_RE_CC1, . . . ). Similarly, the higher layer parameters used for TBS determination may be common to each of the multiple CCs that the TB spans (e.g., N_oh), and may be different for each of the multiple CCs that the TB spans (e.g., N′_oh_CC0, N′_oh_CC1, . . . ).

Furthermore, when two CCs included in the plurality of CCs are adjacent to each other in the frequency domain, TB mapping may be executed for Guard Subcarrier(s) between the two CCs. For example, in the case illustrated in FIGS. 8 and 9, the TB may be mapped to the Guard Subcarrier(s) between the CC #0 and CCC1. In other words, the Guard Subcarrier(s) between consecutive CCs may be used as a resource. The Guard Subcarrier(s) between two CCs may be used for Rate Matching.

### (4.1) TDD Setting

In the case where one TB spans multiple CCs, the TDD setting may be determined as follows.

First, the same TDD (Time Division Duplex) setting may be applied to multiple CCs. The TDD setting is an example of an information element (higher layer parameter) of the RRC message, and may be referred to as TDD UL/DL Common Configuration or TDD UL/DL Dedicated Configuration. Alternatively, the TDD setting may be instructed by a particular DCI (e.g., SFI).

Secondly, if the pattern of symbols to which DL and UL are allocated in the time domain (hereinafter, D/U Type) is the same between multiple CCs, one TB may be mapped across multiple CCs with the same D/U Type. In addition, when CCs with different D/U types are included in the multiple CCs, the existing control of mapping one TB to one CC may be executed.

### (4.2) Resource Allocation

In the case where one TB spans multiple CCs, the size of the FDRA field included in the DCI may be expanded as compared with the existing control of mapping one TB to one CC. The RA Type may be extended with the expansion of the FRDA field. The RA Type is an example of an information element (higher layer parameter) of the RRC message. For example, in the case illustrated in FIG. 8, the PRBs included in the CC #0 and CC #1 may be treated as continuous PRBs between CCs instead of being independent for each CC.

In such a case, the maximum value of the number of PRBs included in an RBG (Resource Block Group) may be expanded as compared with the existing control of mapping one TB to one CC, and the maximum value of the number of RBGs may be increased. The RBG size may be controlled based on at least one of the number of CCs, CC index, and DCI format. Furthermore, parameters used for calculating RIV (Resource Indicator Value), such as L_RBs (or L_RBset), may be adjusted accordingly. In other words, in the case where one TB spans multiple CCs, a newly extended value may be introduced as the parameter used for calculating the number of PRBs included in the RBG, the number of RBGs, and the RIV.

However, the same frequency domain resource may be allocated to multiple CCs. In such a case, since the existing RIV can be used, it is not necessary to introduce a newly extended value as a parameter used for calculating the RIV.

### (4.3) CB Mapping

TB may be divided into two or more CBs (Code Blocks). In the case where one TB spans multiple CCs, each CB may be mapped across multiple CCs. Each CC may be mapped so as to fall within one CC without spanning multiple CCs.

Two or more CBs included in the TB may be combined into one CBG (Code Block Group). In the case where one TB spans multiple CCs, each CBG may be mapped across multiple CCs. Each CC may be mapped so as to fall within one CC without spanning multiple CCs.

The order of mapping TB to multiple CCs may be an order of mapping the TB in the frequency domain across multiple CCs in the nth unit included in the time domain, and then mapping the TB in the frequency domain across multiple CCs in the (n+1)th unit included in the time domain (see, for example, FIG. 9). Alternatively, the order of mapping TB to multiple CCs may be an order of mapping the TB in the frequency domain in the nth unit included in the time domain in the mth CC, and then mapping the TB in the frequency domain in the (n+1)th unit included in the time domain, and then repeating this in the (m+1)th CC. In these cases, TB may be read as CB or CBG described above.

### (4.4) Frequency Hopping

In the case where one TB spans multiple CCs, frequency hopping (FH) may not be set. Further, even if FH is set, FH may not be applied. The information element for setting FH is an example of the information element (higher layer parameter) included in the RRC message.

In the case where one TB spans multiple CCs, if FH is supported, the PRB Index may be defined in a format spanning multiple CCs. For example, in the case illustrated in FIG. 8, the PRB Indexes included in the CC #0 and CC #1 may be defined in a continuous format between CCs instead of being independent for each CC. Alternatively, the PRB that initiates FH may be defined by the CC Index of the CC and the PRB Index within the CC.

### (5) Operation Example

### (5.1) Operation Example 1

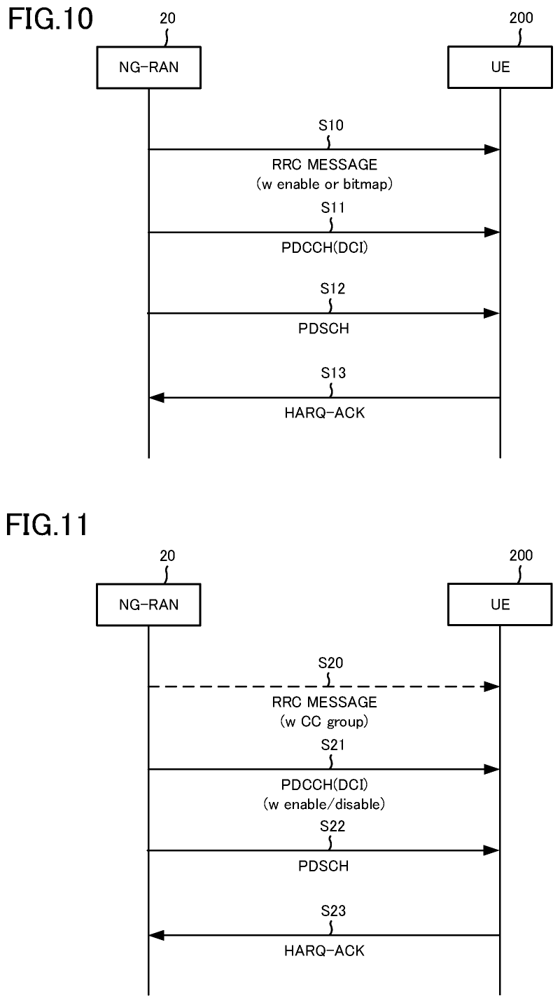

As illustrated in FIG. 10, in step S10, the UE 100 receives, from the NG-RAN 20, an RRC message including an information element instructing the application of the CC group. The information element instructing the application of the CC group may include identification information of the CC group to be applied to the UE 200 and the effect of applying the CC group (for example, enable). Alternatively, the information element instructing the application of the CC group is bitmap information capable of specifying the CC by the bit position, and each bit may be an information element indicating whether the CC corresponding to the bit position is included in the CC group. The information element instructing the application of the CC group may be a combination of CC identification information and an information element indicating whether or not to be included in the CC group.

In step S11, the UE 200 receives one or more DCIs from the NG-RAN 20 via a predetermined CC.

In step S12, the UE 200 receives the PDSCH via the multiple CCs included in the CC group. One TB is mapped across multiple CCs included in the CC group. Here, the UE 200 controls communication of multiple

CCs based on DCI received in step S13. The control of communication may include scheduling of resources used in CC, and may include identification of MCS (Modulation Coding Scheme) applied to CC.

In step S13, the UE 200 may transmit one acknowledgment (HARQ-ACK) for one TB. The UE 200 may transmit HARQ-ACK via a predetermined CC. The predetermined CC may be one or more CCs included in the plurality of CCs. The number of HARQ-ACK bits may be determined according to the type of DCI format used for PDSCH control.

In operation example 1, PDSCH reception is described, but the embodiment may be applied to PUSCH transmission. In such a case, one TB is mapped across multiple CCs.

(5.2) Operation example 2

As illustrated in FIG. 11, in step S20, the UE 100 receives, from the NG-RAN 20, an RRC message including an information element designating a CC included in the CC group. There may be one CC group (see FIG. 5) or two or more CC groups (see FIG. 6). The UE 200 sets a CC group based on the information element included in the RRC message received in step S10.

In step S21, the UE 200 receives one or more DCIs from the NG-RAN 20 via a predetermined CC. The UE 200 specifies the CC group to be applied to the UE 200 based on the information element included in the DCI. For example, the UE 200 specifies the CC group to be applied to the UE 200, based on the CI stored in the CI field included in the DCI.

In step S22, the UE 200 receives the PDSCH via the multiple CCs included in the CC group. One TB is mapped across multiple CCs included in the CC group. Here, the UE 200 controls communication of multiple CCs based on the DCI received in step S32. The control of communication may include scheduling of resources used in CC, and may include identification of MCS to be applied to CC.

In step S23, the UE 200 may transmit one acknowledgment (HARQ-ACK) to one TB. The UE 200 may transmit HARQ-ACK via a predetermined CC. The predetermined CC may be one or more CCs included in the plurality of CCs. The number of HARQ-ACK bits may be determined according to the type of DCI format used for PDSCH control.

FIG. 11 exemplifies a case where the CC group is set by the RRC message, but the CC group may be predetermined and known to the UE 200. In such a case, step S20 described above may be omitted.

In operation example 2, PDSCH reception is described, but the embodiment may be applied to PUSCH transmission. In such a case, one TB is mapped across multiple CCs.

(6) Action and effect

In the embodiment, the UE 200 executes the predetermined communication for receiving the TB across multiple CCs. In such a case, the UE 200 may transmit one HARQ-ACK for one TB. According to such a configuration, even when a large number of CCs are set, it is possible to suppress an increase in resources used for HARQ-ACK, and it is possible to realize efficient communication control of CCs using DCI.

In the embodiment, a new concept of a plurality of CCs (CC group) controlled by DCI received via a predetermined CC is introduced, and the UE 200 controls CC included in the CC group based on the DCI received via a predetermined CC. With such a configuration, it is possible to realize efficient communication control of CCs using DCI even when a large number of CCs are set.

[Modification 1]

Hereinafter, Modification 1 of the embodiment will be described. The differences from the embodiment will be described below.

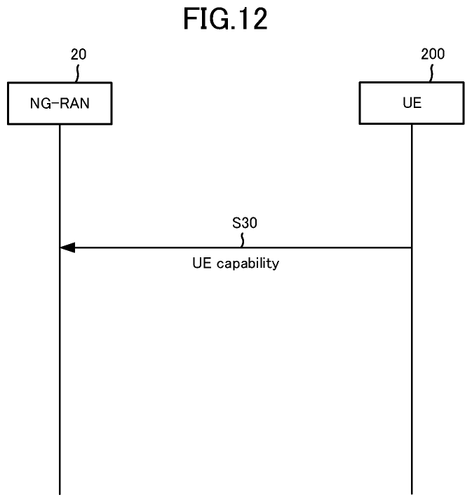

Specifically, the UE 200 transmits, to the network (NG-RAN 20), an information element indicating whether or not the UE 200 has a capability of executing predetermined communication. Specifically, as illustrated in FIG. 12, in step S30, the UE 200 transmits (reports), to the NG-RAN 20, a UE capability including an information element indicating whether or not it has a capability of executing predetermined communication.

Although not particularly limited, the UE 200 may execute step S30 when RRC connection is set with the NG-RAN 20. In other words, step S30 may be executed before the processing illustrated in FIG. 10 or FIG. 11. [Modification 2]

Modification 2 of the embodiment will be described below. The differences from the embodiment will be described below.

In the embodiment, when the CC group including multiple CCs is applied to the UE 200, the predetermined communication is applied to a CC included in the CC group. That is, the predetermined condition for applying the predetermined communication is a condition that the CC group is applied.

On the other hand, in Modification 1, the predetermined condition for applying the predetermined communication is not limited to the condition that the CC group is applied.

The predetermined condition may be a condition that one or more DCIs received via a predetermined CC instruct that the predetermined communication is to be applied (first predetermined condition). The predetermined communication may be applied to multiple CCs used for receiving the DCI instructing to apply the predetermined communication. The DCI may include an information element (enable) indicating to apply the predetermined communication. The DCI may include an information element (disable) indicating not to apply the predetermined communication.

The multiple CCs to which the predetermined communication can be applied may be set by the RRC message or may be predetermined, as in the CC group described above. The multiple CCs to which the predetermined communication can be applied may be the same as the CCs included in the CC group described above, or may be different from the CCs included in the CC group described above.

The predetermined condition may be a condition that the RRC message instructs to apply the predetermined communication (second predetermined condition). The RRC message may include an information element (enable) indicating to apply the predetermined communication. The RRC message may include an information element (disable) indicating not to apply the predetermined communication. The RRC message is bitmap information capable of specifying the CC by the bit position, and each bit may include an information element indicating whether or not the predetermined communication is applied to the CC corresponding to the bit position. The RRC message may include identification information of the CC to which the predetermined communication is applied. The multiple CCs to which the predetermined communication can be applied may be set by the RRC message or may be predetermined, as in the CC group described above. The multiple CCs to which the predetermined communication can be applied may be the same as the CCs included in the CC group described above, or may be different from the CCs included in the CC group described above.

As described above, the UE 200 (controller 270) may determine whether or not a predetermined condition (for example, the above-mentioned first predetermined condition) is satisfied, based on the RRC message including an information element indicating whether or not to apply the predetermined communication. The UE 200 (controller 270) may determine whether or not a predetermined condition (for example, the above-mentioned second predetermined condition) is satisfied, based on the RRC message including an information element indicating whether or not to apply the predetermined communication.

Further, the UE 200 (controller 270) may determine whether or not the predetermined condition is satisfied, based on the RRC message and DCI. For example, the UE 200 may set multiple CCs to which the predetermined communication can be applied by the RRC message, and may specify a CC to which the predetermined communication is applied based on the DCI from the set CCs.

### OTHER EMBODIMENTS

Although the content of the present invention has been described above with reference to the embodiments, the present invention is not limited to these descriptions, and it is obvious to those skilled in the art that various modifications and improvements can be made.

In the above-described embodiment, the RRC message and DCI have been mainly described, but the embodiment is not limited to this. For example, the UE 200 may apply the CC group based on the information element used in MAC CE (Control Element).

Although briefly mentioned in the embodiment, the information element (higher layer parameter) included in the RRC message used in the case where one TB is mapped across multiple CCs may be defined separately from the information element (higher layer parameter) included in the RRC message used in the case where one TB is mapped to one CC.

Although not particularly mentioned in the embodiment, one TB may be mapped across multiple CCs when multiple CCs are included in one BWP. In other words, the predetermined condition may include a condition that multiple CCs are included in one BWP.

Although not particularly mentioned in the embodiment, the present invention may be applied to TB in the PUSCH. That is, one TB may be transmitted in the PUSCH across multiple CCs.

The block configuration diagram (FIG. 4) used for explaining the above-described embodiments illustrates blocks of functional unit. Those functional blocks (components) can be realized by a desired combination of at least one of hardware and software. A realization method for each functional block is not particularly limited. That is, each functional block may be realized by using one device combined physically or logically. Alternatively, two or more devices separated physically or logically may be directly or indirectly connected (for example, by using wire or radio) to each other, and each functional block may be realized by these plural devices. The functional block may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that makes a transmitting function work may be called a transmitting unit or a transmitter. For any of the above, as explained above, the realization method is not particularly limited.

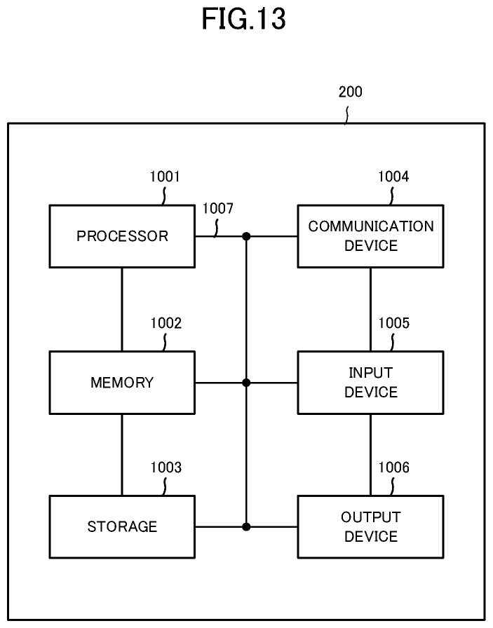

Furthermore, the UE 200 (relevant device) explained above may function as a computer that performs the processing of the radio communication method of the present disclosure. FIG. 13 is a diagram illustrating an example of a hardware configuration of the device. As illustrated in FIG. 13, the device can be configured as a computer device including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. The hardware configuration of the device can be constituted by including one or plurality of the devices illustrated in the figure, or can be constituted without including a part of the devices.

The functional blocks of the device (see FIG. 4) can be realized by any of hardware elements of the computer device or a desired combination of the hardware elements.

Moreover, the processor 1001 performs operation by loading a predetermined software (program) on hardware such as the processor 1001 and the memory 1002, and realizes various functions of the device by controlling communication via the communication device 1004, and controlling at least one of reading and writing of data on the memory 1002 and the storage 1003.

The processor 1001, for example, operates an operating system to control the entire computer. The processor 1001 can be configured with a central processing unit (CPU) including an interface with a peripheral device, a control device, an operation device, a register, and the like.

Moreover, the processor 1001 reads a program (program code), a software module, data, and the like from at least one of the storage 1003 and the communication device 1004 into the memory 1002, and executes various processes according to these. As the program, a program causing the computer to execute at least a part of the operation explained in the above embodiments is used. Alternatively, various processes described above can be executed by one processor 1001 or can be executed simultaneously or sequentially by two or more processors 1001. The processor 1001 may be implemented by using one or more chips.

Alternatively, the program may be transmitted from a network via a telecommunication line.

The memory 1002 is a computer readable recording medium and may be configured, for example, with at least one of Read Only Memory (ROM), Erasable Programmable ROM (EPROM), Electrically Erasable Programmable ROM (EEPROM), Random Access Memory (RAM), and the like. The memory 1002 may be called register, cache, main memory (main storage device), and the like. The memory 1002 can store therein a program (program codes), software modules, and the like that can execute the method according to the embodiment of the present disclosure.

The storage 1003 is a computer readable recording medium.

Examples of the storage 1003 include at least one of an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 may be called an auxiliary storage device. The recording medium may be, for example, a database including at least one of the memory 1002 and the storage 1003, a server, or other appropriate medium.

The communication device 1004 is hardware (transmission/reception device) capable of performing communication between computers via at least one of a wired network and a wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

In addition, the respective devices, such as the processor 1001 and the memory 1002, are connected to each other with the bus 1007 for communicating information therebetween. The bus 1007 may be constituted by a single bus or may be constituted by separate buses between the devices.

Further, the device may be configured to include hardware such as a microprocessor, a digital signal processor (Digital Signal Processor: DSP), Application Specific Integrated Circuit (ASIC), Programmable Logic Device (PLD), and Field Programmable Gate Array (FPGA). Some or all of these functional blocks may be realized by the hardware. For example, the processor 1001 may be implemented by using at least one of these hardware.

Notification of information is not limited to that in the aspect/embodiment described in the present disclosure, and may be performed by using a different method. For example, the notification of information may be performed by physical layer signaling (for example, Downlink Control Information (DCI), Uplink Control Information (UCI), higher layer signaling (for example, RRC signaling, Medium Access Control (MAC) signaling, broadcast information (Master Information Block (MIB), System Information Block (SIB)), other signals, or a combination of these. The RRC signaling may be called RRC message, for example, or may be RRC Connection Setup message, RRC Connection Reconfiguration message, or the like.

Each of the aspects/embodiments described in the present disclosure may be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G) and applied.

As long as there is no inconsistency, the order of processing procedures, sequences, flowcharts, and the like of each of the aspects/embodiments described in the present disclosure may be exchanged. For example, the various steps and the sequence of the steps of the methods explained in the present disclosure are exemplary and are not limited to the specific order mentioned above.

The specific operation that is performed by the base station in the present disclosure may be performed by its upper node in some cases. In a network constituted by one or more network nodes having a base station, it is obvious that the various operations performed for communication with the terminal can be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information and signals (information and the like) can be output from a higher layer (or lower layer) to a lower layer (or higher layer). It may be input and output via a plurality of network nodes.

The input/output information may be stored in a specific location (for example, a memory) or may be managed in a management table. The information to be input/output can be overwritten, updated, or added. The information may be deleted after outputting. The inputted information may be transmitted to another device.

The determination may be made by a value (0 or 1) represented by one bit or by truth-value (Boolean: true or false), or by comparison of numerical values (for example, comparison with a predetermined value).

Each aspect/embodiment described in the present disclosure may be used separately or in combination, or may be switched in accordance with the execution. In addition, notification of predetermined information (for example, notification of “being X”) is not limited to being performed explicitly, it may be performed implicitly (for example, without notifying the predetermined information).

Regardless of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when software is transmitted from a website, a server, or another remote source by using at least one of a wired technology (coaxial cable, optical fiber cable, twisted pair, Digital Subscriber Line (DSL), or the like) and a wireless technology (infrared light, microwave, or the like), then at least one of these wired and wireless technologies is included within the definition of the transmission medium.

Information, signals, or the like described in the present disclosure may be represented by using any of a variety of different technologies. For example, data, instruction, command, information, signal, bit, symbol, chip, or the like that can be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced with terms having the same or similar meanings. For example, at least one of a channel and a symbol may be a signal (signaling). Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like described in the present disclosure may be represented by an absolute value, may be represented by a relative value from a predetermined value, or may be represented by corresponding other information. For example, the radio resource may be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names allocated to these various channels and information elements shall not be restricted in any way.

In the present disclosure, it is assumed that the terms “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of at least one of a base station and a base station subsystem that performs communication service in this coverage.

In the present disclosure, the terms “mobile station (Mobile Station: MS)”, “user terminal”, “user equipment (User Equipment: UE)”, “terminal” and the like can be used interchangeably.

The mobile station may be called a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable term by those skilled in the art.

At least one of a base station and a mobile station may be called a transmitting device, a receiving device, a communication device, or the like. Note that, at least one of a base station and a mobile station may be a device mounted on a moving body, a moving body itself, or the like. The moving body may be a vehicle (for example, a car, an airplane, or the like), a moving body that moves unmanned (for example, a drone, an automatically driven vehicle, or the like), or a robot (manned type or unmanned type). At least one of a base station and a mobile station can be a device that does not necessarily move during the communication operation. For example, at least one of a base station and a mobile station may be an Internet of Things (IoT) device such as a sensor.

Also, a base station in the present disclosure may be read as a mobile station (user terminal, hereinafter the same). For example, each of the aspects/embodiments of the present disclosure may be applied to a configuration in which a communication between a base station and a mobile station is replaced with a communication between a plurality of mobile stations (for example, may be referred to as Device-to-Device (D2D), Vehicle-to-Everything (V2X), or the like). In this case, the mobile station may have the function of the base station. Words such as “uplink” and “downlink” may also be replaced with wording corresponding to inter-terminal communication (for example, “side”). For example, terms such as an uplink channel and a downlink channel may be read as a side channel.

Likewise, a mobile station in the present disclosure may be read as a base station. In this case, the base station may have the function of the mobile station.

A radio frame may be composed of one or more frames in the time domain. Each of one or more frames in the time domain may be referred to as a subframe.

The subframe may also be composed of one or more slots in the time domain. The subframe may have a fixed time length (for example, 1 ms) that does not depend on numerology.

The numerology may be a communication parameter applied to at least one of transmission and reception of a signal or channel. The numerology may indicate, for example, at least one of subcarrier spacing (SCS), bandwidth, symbol length, cyclic prefix length, transmission time interval (TTI), the number of symbols per TTI, radio frame configuration, a specific filtering process performed by a transceiver in the frequency domain, a specific windowing process performed by the transceiver in the time domain, and the like.

The slot may be composed of one or more symbols (Orthogonal Frequency Division Multiplexing (OFDM) symbols, Single Carrier Frequency Division Multiple Access (SC-FDMA) symbols, etc.) in the time domain. The slot may be a time unit based on numerology.

The slot may include multiple minislots. Each minislot may be composed of one or more symbols in the time domain. The minislot may be called a subslot. The minislot may be composed of fewer number of symbols than the slot. PDSCH (or PUSCH) transmitted in a time unit larger than the minislot may be referred to as PDSCH (or PUSCH) mapping type A. The PDSCH (or PUSCH) transmitted using a minislot may be referred to as PDSCH (or PUSCH) mapping type B.

The radio frame, subframe, slot, minislot, and symbol all represent a time unit for transmitting a signal. The radio frame, subframe, slot, minislot, and symbol may have respectively different names corresponding to them.

For example, one subframe may be referred to as a transmission time interval (TTI), a plurality of consecutive subframes may be referred to as TTI, and one slot or one minislot may be referred to as TTI. That is, at least one of the subframe and TTI may be a subframe (1 ms) in existing LTE, a period shorter than 1 ms (e.g., 1 to 13 symbols), or a period longer than 1 ms. The unit representing TTI may be called a slot, a minislot, etc. instead of a subframe.

Here, TTI refers to, for example, the minimum time unit of scheduling in radio communication. For example, in the LTE system, the base station performs scheduling to allocate radio resources (frequency bandwidth that can be used in each user terminal, transmission power, etc.) to each user terminal in units of TTI. The definition of TTI is not limited to this.

The TTI may be a transmission time unit of a channel-encoded data packet (transport block), a code block, a codeword, or the like, or a processing unit of scheduling, link adaptation, or the like. When a TTI is given, the time interval (for example, the number of symbols) in which the transport block, code block, codeword, etc. are actually mapped may be shorter than the TTI.

When one slot or one minislot is called TTI, one or more TTIs (that is, one or more slots or one or more minislots) may be the minimum time unit for scheduling. Also, the number of slots (the number of minislots) forming the minimum time unit of the scheduling may be controlled.

The TTI having a time length of 1 ms may be referred to as usual TTI (TTI in LTE Rel. 8 to 12), normal TTI, long TTI, usual subframe, normal subframe, long subframe, slot, or the like. The TTI shorter than the usual TTI may be called a shortened TTI, a short TTI, a partial TTI (partial or fractional TTI), a shortened subframe, a short subframe, a minislot, a subslot, a slot, or the like.

Note that a long TTI (e.g., usual TTI, subframe, etc.) may be read as a TTI having a time length of more than 1 ms, and a short TTI (e.g., shortened TTI, etc.) may be read as a TTI having a TTI length of less than the TTI length of a long TTI and 1 ms or more.

The resource block (RB) is a resource allocation unit in the time domain and the frequency domain, and may include one or more continuous subcarriers in the frequency domain. The number of subcarriers included in RB may be the same regardless of the numerology, and may be 12, for example. The number of subcarriers included in RB may be determined based on numerology.

Also, the time domain of RB may include one or more symbols, and may be one slot, one minislot, one subframe, or one TTI in length. Each of 1 TTI, 1 subframe, etc. may be composed of one or more resource blocks.

Incidentally, one or more RBs may be called physical resource block (Physical RB: PRB), subcarrier group (Sub-Carrier Group: SCG), resource element group (Resource Element Group: REG), PRB pair, RB pair, and the like.

Further, the resource block may be composed of one or more resource elements (Resource Element: RE). For example, 1 RE may be a radio resource domain of 1 subcarrier and 1 symbol.

The Bandwidth Part (BWP) (which may be called partial bandwidth or the like) may represent a subset of consecutive common RBs (common resource blocks) for certain numerology in a certain carrier. Here, the common RB may be specified by the index of the RB based on the common reference point of the carrier. The PRBs may be defined in a BWP and numbered within the BWP.

The BWP may include a BWP for UL (UL BWP) and a BWP for DL (DL BWP). For the UE, one or more BWPs may be set within one carrier.

At least one of the set BWPs may be active and the UE may not be assumed to transmit or receive a predetermined signal/channel outside the active BWP. Note that “cell”, “carrier”, and the like in the present disclosure may be read as “BWP”.

The structures of the radio frame, subframe, slot, minislot, symbol, etc. described above are merely examples. For example, the configuration of the number of subframes included in a radio frame, the number of slots per subframe or radio frame, the number of minislots included in a slot, the number of symbols and RBs included in a slot or minislot, the number of subcarriers included in the RB, the number of symbols in the TTI, the symbol length, the cyclic prefix (CP) length, and the like can be variously changed.

The terms “connected”, “coupled”, or any variations thereof mean any direct or indirect connection or coupling between two or more elements, and can include that one or more intermediate elements are present between two elements that are “connected” or “coupled” to each other. The coupling or connection between the elements may be physical, logical, or a combination thereof. For example, “connection” may be read as “access”. In the present disclosure, it is conceivable that two elements can be “connected” or “coupled” to each other by using at least one of one or more wires, cables, and printed electrical connections, and as some non-limiting and non-comprehensive examples, by using electromagnetic energy having wavelengths in the radio frequency domain, the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on”.

The “means” in the configuration of each of the above devices may be replaced with “unit”, “circuit”, “device”, or the like.

Any reference to an element using a designation such as “first”, “second”, and the like used in the present disclosure generally does not limit the amount or order of those elements. Such designations can be used in the present disclosure as a convenient method to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive OR.

Throughout this disclosure, for example, during translation, if articles such as “a”, “an”, and “the” in English are added, this disclosure may include that a noun following these articles is used in plural.

The terms “determining” used in this disclosure may encompass a wide variety of actions. “Determining” can include that, for example, judging, calculating, computing, processing, deriving, investigating, searching (looking up, search, inquiry) (e.g., searching in a table, a database, or another data structure), and ascertaining are considered as “determining”. Further, “determining” can include that receiving (for example, receiving information), transmitting (for example, transmitting information), input, output, and accessing (for example, accessing data in a memory) are considered as “determining”. In addition, “determining” can include that resolving, selecting, choosing, establishing, comparing, and the like are considered as “determining”. That is, “determining” may include considering some action as “determining”. In addition, “determining” may be read as “assuming”, “expecting”, “considering”, and the like.

In the present disclosure, the term “A and B are different” may mean “A and B are different from each other”. It should be noted that the term may mean “A and B are each different from C”. Terms such as “leave”, “coupled”, or the like may also be interpreted in the same manner as “different”.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

10 Radio communication system
20 NG-RAN
100 gNB
200 UE
210 Radio signal transmitting/receiving unit
220 Amplifier unit
230 Modulation/demodulation unit
240 Control signal/reference signal processing unit
250 Encoding/decoding unit
260 Data transmitting/receiving unit
270 Controller
1001 Processor
1002 Memory
1003 Storage
1004 Communication device
1005 Input device
1006 Output device
1007 Bus

1. A terminal comprising:
a communication unit that executes data communication via a plurality of component carriers; and
a receiving unit that executes predetermined communication that is communication of a transport block across the plurality of component carriers.

2. The terminal according to claim 1, further comprising a controller that determines to apply the predetermined communication, when the communication of the plurality of component carriers is controlled using downlink control information received via a predetermined component carrier.

3. The terminal according to claim 1 further comprising a controller that determines whether to apply the predetermined communication based on an information element included in an RRC message received from a network.

4. The terminal according to claim 1, further comprising a controller that determines whether to apply the predetermined communication based on an information element included in downlink control information received from a network.

5. The terminal according to claim 1, further comprising a transmitting unit that transmits, to a network, an information element indicating whether or not the terminal has a capability of executing the predetermined communication.

6. The terminal according to claim 2, further comprising a controller that determines whether to apply the predetermined communication based on an information element included in an RRC message received from a network.

7. The terminal according to claim 2, further comprising a controller that determines whether to apply the predetermined communication based on an information element included in downlink control information received from a network.

8. The terminal according to claim 2, further comprising a transmitting unit that transmits, to a network, an information element indicating whether or not the terminal has a capability of executing the predetermined communication.
